(19) United States
(12) Patent Application Publication
(10) Pub. No.: US 2026/0265542 A1
(43) Pub. Date: Sep. 10, 2026

(54) ELECTRICALLY-CONDUCTIVE PRIMER COATING COMPOSITIONS, A PROCESS FOR PRODUCTION THEREOF, COATING FILMS USING THE SAME, AND PROCESSES FOR FORMING MULTILAYER COATING FILMS

(71) Applicant: BASF COATINGS GMBH, Muenster (DE)

(72) Inventors: Shintaro SATO, Kanagawa (JP); Hideki SUETSUGU, Kanagawa (JP)

(21) Appl. No.: 19/491,426

(22) PCT Filed: May 27, 2024
(86) PCT No.: PCT/EP24/64507

§ 371 Date: Dec. 9, 2025

(30) Foreign Application Priority Data
Jun. 23, 2023 (JP) 2023-103759

(51) Int. Cl. C09D 5/24; C08K 5/29; C09D 7/63; C09D 133/16

(52) U.S. Cl. CPC C09D 5/24; C08K 5/29; C09D 7/63; C09D 133/16; C08K 2201/001

(57) ABSTRACT

Described herein are electrically-conductive primer coating compositions which include (C) an electrically-conductive pigment paste produced by dispersing (A) an electrically-conductive pigment in (B) a non-chlorinated polyolefin resin which includes hydroxy groups, (D) an acrylic resin-modified chlorinated polyolefin resin, and (E) a blocked polyisocyanate compound. Also described are a process for production thereof, primer coating films formed from these electrically-conductive primer coating compositions, and processes for forming multilayered coating films.

### TECHNICAL FIELD

The present invention relates to electrically-conductive primer coating compositions, a process for production thereof, coating films using the same, and processes for forming multilayer coating films.

### BACKGROUND ART

In order to electrostatically coat a topcoat on plastic substrate materials, using an electrically-conductive primer coating composition as an undercoat intended to confer electrical conductivity, is known art, and the existence of electrically-conductive pigments as agents for conferring electrical conductivity is also widely known.

In recent years, in order to improve productivity, there is a desire for electrically-conductive primer coating compositions which confer outstanding electrically conductivity on plastic substrate materials, even directly after coating, while still including solvents. Thus, if, after coating an electrically-conductive primer, the substrate materials could be subjected to electrostatic coating in the next process without waiting for complete drying, the production line from primer coating to topcoat coating could be shortened, production time could be saved, and productivity could be improved. Therefore, making electrically-conductive primer coating compositions which are electrically-conductive immediately after coating has industrial merits.

Moreover, from the point of view of cutting energy use, it is desirable that these show good adhesion between different type of plastic substrate materials and topcoat coating films, with heating at a low temperature for a short time.

From the viewpoint of electrical conductivity immediately after coating, for example, Patent document 1 discloses electrically-conductive primer coating compositions comprising (A) a chlorinated polyolefin resin which does not contain hydroxy groups, or a chlorinated polyolefin resin which does not contain hydroxy groups and a non-chlorinated polyolefin resin which does not contain hydroxy groups, (B) a blocked polyisocyanate, and (C) electrically-conductive carbon, characterized in that the ratio A/B by mass of solids is 50/50-90/10, and (C) is 3-30 parts by mass in 100 parts by mass of resin solids; and it is claimed that these coating compositions can confer electrical conductivity on plastic substrate materials from immediately after coating, and can also give good adhesion.

In addition, in connection with achieving low-temperature curing condition, Patent Document 2 discloses coating compositions containing a specified acrylic resin (A), a polyolefin resin which may be chlorinated (B), and also a pyrazole-blocked polyisocyanate compound and/or an active-methylene-blocked polyisocyanate compound (C), in which in 100 parts by mass of total solids of constituent (A), constituent (B), and constituent (C), constituent (A) is 10-50 parts by mass, constituent (B) is 20-60 parts by mass, and constituent (C) is 5-30 parts by mass. According to this document it is claimed that electrical conductivity can be conferred by these coating compositions, and they can form coating films with good adhesion and water-resistance under low-temperature curing conditions. Moreover, Patent document 3 discloses coating compositions which include a chlorinated and/or non-chlorinated polyolefin (A), an acrylic-modified styrene-based thermoplastic elastomer (B), an epoxy resin (C), a blocked polyisocyanate compound (D), and a pigment (E), and it is claimed that with these coating compositions it is possible to form coating films which have outstanding chipping resistance, adhesion and gasoline resistance on both metal materials and plastic materials.

### PRIOR ART DOCUMENTS

### Patent Documents

[Patent document 1] JP 4400292 B2
[Patent document 2] JP 2012-193320 A
[Patent document 3] JP 2019-167390 A

### SYNOPSIS OF THE INVENTION

### Problem which the Invention is Intended to Solve

However, in the case of the coating compositions in Patent document 1, although plastic materials are given a certain degree of electrical conductivity immediately after coating, it is necessary to heat at 120° C. for 20 minutes to harden the coating composition. In addition, in the case of the coating compositions in Patent documents 2 and 3, electrical conductivity is not obtained immediately after coating. In addition, the curing temperature of these coating compositions needs to be, for example, 95° C. for 30 minutes (Patent document 2), and 80° C. for 30 minutes (Patent document 3); therefore, from the viewpoint of dealing with environmental problems, curing at a lower temperature for a shorter time is desired.

Accordingly, the problem addressed by this invention is to offer electrically-conductive primer coating compositions which can confer outstanding electrical conductivity on plastic substrate materials immediately after coating, while it still includes solvents, and have good adhesion between different type of plastic substrate materials and topcoat coating films with heating at a low temperature for a short time, it is also to offer a process for production thereof, primer coating films formed from these electrically-conductive primer coating compositions, and processes for forming multilayer coating films.

### Means for Solving the Problem

As the result of intensive studies to solve the aforementioned problem, the present inventors have perfected the present invention with the discovery in which the problem can be solved by electrically-conductive primer coating compositions which include (C) an electrically-conductive pigment paste which includes (A) an electrically-conductive pigment dispersed in (B) a non-chlorinated polyolefin resin which includes hydroxy groups, with (D) an acrylic resin-modified chlorinated polyolefin resin, and (E) a blocked polyisocyanate compound.

Moreover, in electrically-conductive primer coating compositions of the present invention the mass ratio of resin solids of (B) non-chlorinated polyolefin resin which includes hydroxy groups and (D) acrylic resin-modified chlorinated polyolefin resin is preferably 10/90-60/40.

Moreover, in electrically-conductive primer coating compositions of the present invention, the sum of resin solids of (B) non-chlorinated polyolefin resin which includes hydroxy groups and (D) acrylic resin-modified chlorinated polyolefin resin, is preferably 10 parts by mass or more in 100 parts by mass of total resin solids in the electrically-conductive primer coating composition.

Moreover, in electrically-conductive primer coating compositions of the present invention, (B) non-chlorinated polyolefin resin which includes hydroxy groups preferably has a hydroxyl value of 15-90 mgKOH/g.

Moreover, in electrically-conductive primer coating compositions of the present invention, (D) acrylic resin-modified chlorinated polyolefin resin preferably has a mass-average molecular weight of 20,000-150,000.

Moreover, in electrically-conductive primer coating compositions of the present invention, (E) blocked polyisocyanate compound is preferably an active-methylene-blocked polyisocyanate compound.

Moreover, in electrically-conductive primer coating compositions of the present invention, (A) electrically-conductive pigment preferably includes a black electrically-conductive pigment and/or a white electrically-conductive pigment.

Moreover, the problem above addressed by this invention is also solved by a process for producing an electrically-conductive primer coating composition characterized by making (C) an electrically-conductive pigment paste by dispersing (A) an electrically-conductive pigment in (B) a non-chlorinated polyolefin resin which includes hydroxy groups, and then mixing (C) the electrically-conductive pigment paste, (D) an acrylic resin-modified chlorinated polyolefin resin, and (E) a blocked polyisocyanate compound.

The problem addressed by this invention is also solved by primer coating films which are dried coating films of the electrically-conductive primer coating composition above.

Primer coating films of this invention on plastic substrate materials preferably have a lightness L* value of 20-70 in the CIE LAB colour system.

In addition, primer coating films of this invention preferably have a dry film thickness of 2-20 μm.

The problem addressed by this invention is also solved by a process for forming a multilayer coating film, characterized by a step (1) of coating the electrically-conductive primer coating composition described above onto plastic substrate materials, and forming an electrically-conductive coating film, coating a one-coat coating composition onto the electrically-conductive coating film obtained in the step (1) above, and curing.

The problem addressed by this invention is also solved by a process for forming a multilayer coating film, characterized by a step (1) of coating the electrically-conductive primer coating composition described above onto plastic substrate materials, and forming an electrically-conductive coating film, a step (2) of coating a basecoat coating composition onto the electrically-conductive coating film obtained in the step (1) above to obtain a basecoat coating film, coating a clearcoat coating composition onto the basecoat coating film obtained in the step (2), and curing.

### Effects of the Invention

With an electrically-conductive primer coating composition of the present invention, it is possible to confer outstanding electrical conductivity on plastic substrate materials immediately after coating, while it includes solvents, and to give good adhesion between different type of plastic substrate materials and topcoat coating films with heating at a low temperature for a short time. Owing to this, the resulting multilayer coating films show outstanding water-resistant adhesion between the plastic substrate materials and the topcoat coating films above them.

### SIMPLIFIED DESCRIPTION OF THE DRAWINGS

FIG. 1 is a schematic drawing to explain the method for measuring the surface electrical resistance of the uncured primer coating film in the examples of this invention and the comparative examples.

### MODES FOR CARRYING OUT THE INVENTION

Electrically-conductive primer coating compositions of the present invention include, (C) an electrically-conductive pigment paste made by dispersing (A) an electrically-conductive pigment in (B) a non-chlorinated polyolefin resin which includes hydroxy groups, and
(D) an acrylic resin-modified chlorinated polyolefin resin, and
(E) a blocked polyisocyanate compound.

In these materials, (C) the electrically-conductive pigment paste includes (A) the electrically-conductive pigment and (B) the non-chlorinated polyolefin resin which includes hydroxy groups as essential constituents.

There is no particular restriction as to (A) the electrically-conductive pigment employed in the present invention, provided that it can confer electrical conductivity on the coating film formed, and it can take any form, such as particles, flakes or fibres (including whiskers), etc. There is no particular restriction as to the colour of (A) the electrically-conductive pigment employed in the present invention, provided that it can confer electrical conductivity on the coating film, but preferred electrically-conductive pigments are black electrically-conductive pigments and/or white electrically-conductive pigments.

The black electrically-conductive pigments employed in the present invention include electrically-conductive carbon black, carbon nanotubes, graphite, and carbon fibres; In these black electrically-conductive pigments, electrically-conductive carbon black is preferred. Commercially available electrically-conductive carbon black includes Mitsubishi electrically-conductive carbon black #3030B, #3050B, #3230B, and #3400B (proprietary names, produced by Mitsubishi Chemical Corp.), Ketjenblack EC300J and EC600JD (proprietary names, produced by Lion Specialty Chemicals Co., Ltd.), VULCAN XC72 and XC605 (proprietary names, produced by Cabot Corp.), Chezacarb AC10, AC20, AC30, AC50, AC60, AC70, AC80, and AC90 (proprietary names, produced by Orlen Unipetrol), Denka Black (proprietary name, produced by Denka Co., Ltd.), etc. These black electrically-conductive pigments can be used individually or in combinations of two or more.

The white electrically-conductive pigments employed in the present invention include titanium oxide products surface-coated with tin oxide or tin-antimony oxide, or potassium titanate fibre derivative products surface-coated with an transparent electrically-conductive layer. Commercially available white electrically-conductive pigments include white electrically-conductive powders W-1 and W-4 (proprietary names, produced by Mitsubishi Materials Electronic Chemicals Co., Ltd.), white electrically-conductive materials ET-300W and ET-500W (proprietary names, produced by Ishihara Sangyo Kaisha, Ltd.), etc. as powder types; white electrically-conductive materials FT-1000, FT-2000, FT-3000, and FT-4000 (proprietary names, produced by Ishihara Sangyo Kaisha, Ltd.), and Dentall WK-200B, WK-500, WK-500B (proprietary names, produced by Otsuka Chemical Co., Ltd.), etc. as fibrous types. These white electrically-conductive pigments can be used individually or in combinations of two or more.

There is no particular restriction as to (B) the non-chlorinated polyolefin resin which includes hydroxy groups employed in the present invention; examples include products copolymerized or graft polymerized by a known process using one or two or more selected from C₂₋₁₀ olefins such as ethylene, propylene, butene, methylbutene, hexene, butadiene isoprene, etc., and one or two or more selected from ethylenic unsaturated monomers containing a hydroxy group, which include (meth)acrylic acid esters having a hydroxy group such as hydroxyethyl (meth)acrylate, unsaturated alcohols such as allyl alcohol, vinyl ethers having a hydroxy group such as hydroxyethyl vinyl ether, etc. as essential constituents.

A hydroxyl value of (B) the non-chlorinated polyolefin resin which includes hydroxy groups employed in the present invention is preferably 15-90 mgKOH/g; 20-85 mgKOH/g is more preferable, and 25-80 mgKOH/g is particularly preferable. By making the hydroxyl value of (B) the non-chlorinated polyolefin resin which includes hydroxy groups 15-90 mgKOH/g, it is possible to confer outstanding water-resistant adhesion on resulting multilayer films.

In this invention, hydroxyl value is the value measured in accordance with JIS-K 1557.

The mass-average molecular weight of (B) the non-chlorinated polyolefin resin which includes hydroxy-1 groups employed in the present invention is preferably 4,500-100,000; 4,700-95,000 is more preferable, and 4,800-90,000 is particularly preferable. By making the mass-average molecular weight of (B) the non-chlorinated polyolefin resin which includes hydroxy groups 4,500-100,000, it is possible to confer outstanding electrical conductivity on plastic substrate materials immediately after coating, while it includes solvents.

In this invention, mass-average molecular weight is the mass-average molecular weight measured by gel permeation chromatography (GPC). The measurement is made using tetrahydrofuran (THF) as eluent, at temperature of 40° C. and a flow speed of 1 ml/minute, with polystyrene standards. The gel permeation chromatography (GPC) columns used were TSKgel G2000HXL, G3000HXL, G4000HXL, and G5000HXL (proprietary names, produced by Tosoh Corp.).

Commercially available (B) non-chlorinated polyolefin resins which includes hydroxy groups include, for example, Polytail H (proprietary name, produced by Mitsubishi Chemical Corp.), Unistole P-801 and P-901 (proprietary name, produced by Mitsui Chemicals Inc.), NISSO-PB-G-1000, NISSO-PB-G-2000, NISSO-PB-G-3000, NISSO-PB-GI-1000, NISSO-PB-GI-2000, and NISSO-PB-GI-3000 (proprietary names, produced by Nippon Soda Co., Ltd.), etc.

The ratio of solids (mass ratio) of (A) the electrically-conductive pigment, and (B) the non-chlorinated polyolefin resin which includes hydroxy groups, in (C) an electrically-conductive pigment paste employed in the present invention, is preferably 10/90-96/4; 12/88-94/6 is more preferable, and 14/86-92/8 is particularly preferable. By making the ratio of solids of (A) the electrically-conductive pigment and (B) the non-chlorinated polyolefin resin which includes hydroxy groups 10/90-96/4, (A) the electrically-conductive pigment forms comparatively large aggregates (also termed structures) in (C) the electrically-conductive pigment paste. And when an electrically-conductive primer coating composition which includes this (C) electrically-conductive pigment paste is coated, the aggregates of (A) the electrically-conductive pigment immediately form a three-dimensional structure in the coating film formed on plastic substrate materials. Consequently, immediately after coating, although the electrically-conductive primer coating composition has not completely dried and still includes solvents, it can confer outstanding electrical conductivity on plastic substrate materials.

It should be noted that in the present invention “immediately after coating” means within about 30 seconds at room temperature (25° C.) and atmospheric pressure, although it will also depend on the coating environment. In addition, “it still includes solvents” means a state before the mass of the primer coating film of the electrically-conductive primer coating composition reaches the mass after curing.

Optionally, organic solvents, resins, and non-conductive pigments can also be suitably included in (C) the electrically-conductive pigment paste employed in the present invention. However, pigment dispersants, etc. which could hinder formation of aggregates of (A) the electrically-conductive pigment are preferably not included.

Examples of organic solvents include aromatic hydrocarbons such as toluene, xylene, and aromatic naphtha (Solvesso #100 (proprietary name), etc.), alcohols such as methyl alcohol, isopropyl alcohol, and n-butyl alcohol, ketones such as acetone, methyl ethyl ketone, and methyl amyl ketone, esters such as ethyl acetate, n-butyl acetate, 2-butoxyethyl acetate, pentyl acetate, and ethyl ethoxypropionate, ethers, aliphatic hydrocarbons including chlorinated hydrocarbons, etc. These organic solvents can be used individually or in combinations of two or more.

In addition, examples of resins include acrylic resins, polyester resins, epoxy resins, chlorinated polyolefin resins, etc. These resins can be used individually or in combinations of two or more.

It should be noted that resins with functional groups such as amino groups or imino groups which prevent formation of aggregates of (A) the electrically-conductive pigment are preferably not included.

In addition, non-electrically-conductive pigments include, for example, coloured pigments which include inorganic pigments such as titanium oxide pigments, iron oxide pigments, composite oxide pigments containing titanium yellow, etc., and organic pigments such as azo pigments, quinacridone pigments, diketopyrrolopyrrole pigments, perylene pigments, perinone pigments, benzimidazolone pigments, isoindoline pigments, isoindolinone pigments, azo-metal chelate pigments, phthalocyanine pigments, anthraquinone pigments, dioxazine pigments, threne pigments, indigo pigments, etc., and extender pigments such as calcium carbonate, barium sulphate, aluminium hydroxide, talc, silica, etc. These non-electrically-conductive pigments can be used individually or in combinations of two or more.

In addition, other than (C) the electrically-conductive pigment paste, the electrically-conductive primer coating compositions of the present invention also include (D) the acrylic resin-modified chlorinated polyolefin resin and (E) the blocked polyisocyanate compound.

There is no particular restriction as to (D) the acrylic resin-modified chlorinated polyolefin resin employed in this invention; examples include chlorinated products copolymerized or graft polymerized by a known process using one or two or more selected from C₂₋₁₀ olefins such as ethylene, propylene, butene, methylbutene, hexene, butadiene, isoprene, etc., and one or two or more selected from acrylic monomers such as (meth)acrylic acid, (meth)acrylic acid esters, as basic constituents. It should be noted that when copolymerizing or graft polymerizing, ethylenic unsaturated monomers such as maleic acid, maleic anhydride, fumaric acid, styrene, acrylonitrile, vinyl acetate, etc. can also be included as other monomers.

A mass-average molecular weight of (D) the acrylic resin-modified chlorinated polyolefin resin, employed in this invention, is preferably 20,000-150,000; 22,000-140,000 is more preferable, and 25,000-130,000 is particularly preferable. By making the mass-average molecular weight of (D) the acrylic resin-modified chlorinated polyolefin resin 20,000-150,000, it is possible to confer outstanding water-resistant adhesion on multilayer coating films.

A hydroxyl value of (D) the acrylic resin-modified chlorinated polyolefin resin employed in the present invention is preferably 2-70 mgKOH/g; 4-65 mgKOH/g is more preferable, and 5-60 mgKOH/g is particularly preferable. By making the hydroxyl value of (D) the acrylic resin-modified chlorinated polyolefin resin 2-70 mgKOH/g, it is possible to confer outstanding water-resistant adhesion on multilayer coating films.

A chlorine content of (D) the acrylic resin-modified chlorinated polyolefin resin employed in this invention is preferably 0.1-55 mass %; 0.5-45 mass % is more preferable, and 1-35 mass % is particularly preferred. By making the chlorine content of (D) the an acrylic resin-modified chlorinated polyolefin resin 0.1-55 mass %, it is possible to confer outstanding water-resistant adhesion on multilayer coating films.

Commercially available (D) acrylic resin-modified chlorinated polyolefin resin includes, for example, Superchlon 224H, 223M, and 240H (proprietary names, produced by Nippon Paper Industries Co., Ltd.), ACRYDIC WFL-367, WML-350, CL-408, and CL-1000 (proprietary names, produced by DIC Corp.), etc.

In the electrically-conductive primer coating compositions of the present invention, the ratio of resin solids of the aforementioned (B) non-chlorinated polyolefin resin which includes hydroxy groups and (D) acrylic resin-modified chlorinated polyolefin resin is preferably 10/90-60/40; 15/85-55/45 is more preferable, and 20/80-50/50 is particularly preferable. By making the ratio of resin solids of (B) the non-chlorinated polyolefin resin which includes hydroxy groups and (D) the acrylic resin-modified chlorinated polyolefin resin 10/90-60/40, it is possible confer outstanding electrical conductivity on plastic substrate materials immediately after coating, while it includes solvents, and it is possible to confer outstanding water-resistant adhesion on multilayer coating films.

The sum of resin solids of (B) the non-chlorinated polyolefin resin which includes hydroxy groups and (D) the acrylic resin-modified chlorinated polyolefin resin included is preferably 10 parts by mass or more in 100 parts by mass of total resin solids in the electrically-conductive primer coating composition; 15-95 parts by mass is more preferable, and 20-90 parts by mass is particularly preferable. By making the sum of resin solids of (B) the non-chlorinated polyolefin resin which includes hydroxy groups and (D) the acrylic resin-modified chlorinated polyolefin resin included 10 parts by mass or more in 100 parts by mass of total resin solids in the electrically-conductive primer coating composition, it is possible to confer outstanding water-resistant adhesion on multilayer coating films.

There are no particular restrictions as to a isocyanate compound for (E) the blocked polyisocyanate compound employed in the present invention, provided that it can be used for coating applications; and various types of polyisocyanate compound can be employed. 13or example, various types of polyisocyanate compound such as aromatic polyisocyanate compounds and aliphatic or alicyclic polyisocyanate compounds can be employed. Suitable polyisocyanate compounds include, for example, toluene diisocyanate (TDI), 4,4′-diphenylmethane diisocyanate (MDI), xylene diisocyanate (XDI), hexamethylene diisocyanate (HDI), lysine diisocyanate (LDI), 2-isocyanatoethyl-2,6-diisocyanatocaproate (LTI), isophorone diisocyanate (IPDI), 2,2,4-trimethylhexamethylene diisocyanate (TMDI), hydrogenated TDI, hydrogenated MDI, hydrogenated XDI, etc. Moreover, uretdione structures, allophanate structures, adduct structures, biuret structures, isocyanurate structures, iminooxadiazinedione structures, etc. using these polyisocyanate compounds are employed are also included. These polyisocyanate compounds can be used individually or in combinations of two or more.
(E) The blocked polyisocyanate compounds include the aforementioned polyisocyanate compounds in which the isocyanate group is blocked, for example, by a compound including alcohols such as butanol, oximes such as butyl ethyl ketoxime, lactams such as ε-caprolactam derivatives, active-methylenes such as malonic acid diesters and acetoacetic acid esters, pyrazoles such as 3,5-dimethylpyrazole, imidazoles such as imidazole and 2-ethylimidazole, phenols such as m-cresol, etc.

Among active-methylene compounds above, malonic acid diesters include dimethyl malonate, diethyl malonate, diisopropyl malonate, n-propyl malonate, n-butyl malonate, ethyl n-butyl malonate, methyl n-butyl malonate, ethyl t-butyl malonate, methyl t-butyl malonate, dibenzyl malonate, diphenyl malonate, benzyl methyl malonate, ethyl phenyl malonate, t-butyl phenyl malonate, etc. In addition, acetoacetic acid esters include methyl acetoacetate, ethyl acetoacetate, isopropyl acetoacetate, n-propyl acetoacetate, t-butyl acetoacetate, n-butyl acetoacetate, benzyl acetoacetate, phenyl acetoacetate, etc. These active-methylene compounds can be used individually or in combinations of two or more.

As (E) the blocked polyisocyanate compound employed in the present invention, an active-methylene-blocked polyisocyanate compound is more preferred, and a malonic acid diester-blocked polyisocyanate compound is particularly preferred.

The electrically-conductive primer coating compositions of the present invention can further include an epoxy resin. There are no particular restrictions as to the epoxy resin used in this invention, provided that it has at least two epoxy groups per molecule, and known epoxy resins can be used. Examples include bisphenol A type epoxy resins, bisphenol F type epoxy resins, phenol novolac type epoxy resins, cresol novolac type epoxy resins, naphthalene type epoxy resins, biphenyl type epoxy resins, cyclopentadiene type epoxy resins, etc., and a product which has an epoxy equivalent of 150-250 and is a liquid at room temperature (25° C.) is preferred. These epoxy resins can be used individually or in combinations of two or more.

Commercially available epoxy resins which have an epoxy equivalent of 150-250 and are liquid at room temperature (25° C.) include, for example, jER825, jER827, jER828, jER828EL, jER828US, and jER828XA (proprietary names, produced by Mitsubishi Chemical Corp.), YD-115, YD-115CA, YD-127, YD-128, YD-128G, YD-128S, YD-128CA, YD-8125, YD-825GS, YDF-170, YDF-170N, YDF-8170C, YDF-870GS, and ST-3000 (proprietary names, produced by NIPPON STEEL Chemical & Material Co., Ltd.), etc.

Optionally, the electrically-conductive primer coating compositions of the present invention can further include resins such as polyester resins, urethane resins, acrylic resins, phenol resins, polyether resins, non-chlorinated polyolefin resins which do not contain hydroxy groups, etc. In addition, additives such as curing catalysts, antisagging agents, anticissing agents, etc., conventionally employed in the coating field, can be used as appropriate. However, pigment dispersants, etc. which could hinder formation of aggregates of (A) the electrically-conductive pigment, are preferably not included.

A content of (A) the electrically-conductive pigment included in the electrically-conductive primer composition of the present invention is preferably 3-115 parts by mass, more preferably 4-105 parts by mass, and particularly preferably 5-95 parts by mass in parts by mass of total resin solids in the electrically-conductive primer coating composition. By making the content of (A) the electrically-conductive pigment 3-115 parts by mass, it is possible to confer outstanding electrical conductivity on plastic substrate materials immediately after coating, while it includes solvents.

Moreover, the electrically-conductive primer coating compositions of the present invention can be adjusted, by using an organic solvent, to a viscosity which facilitates production. Organic solvents include organic solvents commonly used to produce primer coatings; examples include aromatic hydrocarbons such as toluene, xylene, and aromatic naphtha (Solvesso #100 (proprietary name), etc.), alcohols such as methyl alcohol, isopropyl alcohol, and n-butyl alcohol, ketones such as acetone, methyl ethyl ketone, and methyl amyl ketone, esters such as ethyl acetate, n-butyl acetate, 2-butoxyethyl acetate, pentyl acetate, ethyl ethoxypropionate, ethers, aliphatic hydrocarbons including chlorinated hydrocarbons, etc. These organic solvents can be used individually or in combinations of two or more.

The electrically-conductive primer coating compositions of the present invention can be produced by making (C) the electrically-conductive pigment paste by dispersing (A) the electrically-conductive pigment in (B) the non-chlorinated polyolefin resin which includes hydroxy groups, and then mixing the resulting (C) electrically-conductive pigment paste with (D) the acrylic resin-modified chlorinated polyolefin resin, (E) the blocked polyisocyanate compound, and optionally, resins, additives, organic solvents, etc.
(C) The electrically-conductive pigment paste of the present invention can be produced by mixing and dispersing (A) the electrically-conductive pigment, (B) the non-chlorinated polyolefin resin which includes hydroxy groups, and optionally, organic solvents, resins, anon-electrically-conductive pigments, etc., mentioned above. A non-volatile content in (C) the electrically-conductive pigment paste is 10-50 mass %, and preferably 15-45 mass %.

It should be noted that mixing and dispersing can be carried out by a conventional method, using a known mixing device and dispersing device.

There is no particular restriction as to a method for coating the electrically-conductive primer coating composition of the present invention, but for example, it can be coated by air-spray coating, airless-spray coating, or high-volume low-pressure (HVLP) coating, etc. The electrically-conductive primer coating compositions of the present invention can confer outstanding electrical conductivity on plastic substrate materials, even when the electrically-conductive primer coating composition has not completely dried and still includes solvents. Although there is no particular restriction as to a dry film thickness of the primer coating film, the dry thickness is preferably 2-20 μm. With a dry film thickness of 5-15 μm even more outstanding electrical conductivity can be conferred on plastic substrate materials, and this is particularly preferred. In addition, primer coating films of this invention on plastic substrate materials preferably have a lightness L* value of 20-70 in the CIE LAB colour system. By making the lightness L* value on plastic substrate materials 20-70 in the CIE LAB colour system, it is possible to prevent the colour of the plastic substrate materials from having an adverse effect on the colour of the final coating film after coating topcoat material(s).

There is no particular restriction as to application of the coated plastic substrate materials; however, for example, automobile outer sheet members such as bumpers, spoilers, grills, fenders, etc., and automobile components such as wing mirrors, door handles, etc., are preferred.

As materials constituting the plastic substrate, for example, polyolefin resins obtained by polymerizing one or two or more selected from C₂₋₁₀ olefins such as ethylene, propylene, butene, methylbutene, hexene, butadiene, isoprene, etc. are preferred. Polyolefin resin alloy materials of one or more polyolefins mixed with other resins can also be used. Other resins in the alloys include polyamide resins, poly(ethylene terephthalate) resins, poly(butylene terephthalate) resins, poly(vinyl chloride) resins, ethylene-propylene-diene monomer copolymer rubbers (EPDM), ethylene-propylene copolymer rubbers (EPR), thermoplastic elastomers, etc. Other resins used in the alloys can be used individually or in combinations of two or more.

Other materials constituting the plastic substrate to be coated include, for example, polycarbonate resins, acrylonitrile-butadiene-styrene (ABS) resins, polycarbonate-acrylonitrile-butadiene-styrene (PCABS) resins, acrylate-styrene-acrylonitrile (ASA) resins, carbon-fibre-reinforced plastics (CFRP), glass-fibre-reinforced plastics (GFRP), urethane resins, nylons, etc.

These plastic substrate materials can contain, for example, one or two of UV absorbing agents, antioxidants, release agents, antistatic agents, colouring agents, flame retardants, plasticizers, reinforcing material such as fibre glass, inorganic fillers, etc. so as to satisfy the properties for the application thereof. In addition, these plastic substrate materials can be undergone suitable treatment previously such as degreasing treatment, washing treatment, etc. by methods that in themselves are known.

A topcoat coating material coated on top of the electrically-conductive primer coating film obtained by coating the electrically-conductive primer coating composition of the present invention can be a one-coat coating composition, or a combination of a basecoat coating composition and a clearcoat coating composition.

As the one-coat coating composition, an acrylic-urethane resin coating material or a polyester-urethane resin coating material is generally used, but provided that it can be cured at a temperature which will not cause deformation of the plastic substrate materials, another thermosetting resin coating composition such as an acrylic-melamine resin coating material, etc. can be used. The one-coat coating composition can be a one-component type or a two-component type, it can be a solvent-based coating material or a water-based coating material, and various additives can optionally be employed.

In addition, pigments for the one-coat coating composition include, coloured pigments which include inorganic pigments such as titanium oxide pigments, iron oxide pigments, composite oxide pigments titanium yellow, etc., organic pigments such as azo pigments, quinacridone pigments, diketopyrrolopyrrole pigments, perylene pigments, perinone pigments, benzimidazolone pigments, isoindoline pigments, isoindolinone pigments, azo-metal chelate pigments, phthalocyanine pigments, anthraquinone pigments, dioxazine pigments, threne pigments, indigo pigments, etc., and carbon black, photoluminescent pigments such as aluminium flake pigments, vapour deposited aluminium pigments, aluminium oxide pigments, metal oxide-coated aluminium oxide pigments, mica pigments, metal oxide-coated mica pigments, glass flake pigments, etc., and extender pigments such as calcium carbonate, barium sulphate, aluminium hydroxide, talc, silica, etc. These pigments can be used individually or in combinations of two or more.

As the basecoat coating composition and the clearcoat coating composition, same as the one-coat coating composition, an acrylic-urethane resin coating material or a polyester-urethane resin coating material is generally used, but provided that it can be cured at a temperature which will not cause deformation of the plastic substrate materials another thermosetting resin coating composition such as acrylic-melamine resin coating material can be used. The basecoat coating composition and the clearcoat coating composition can be one-component types or two-component types, they can be solvent-based coating materials or water-based coating materials, and various additives can optionally be employed.

In addition, the pigments used in the basecoat coating composition include those mentioned in the aforementioned one-coat coating composition. Those pigments can be used individually or in combinations of two or more. Moreover, various pigments can also be included in the clearcoat coating composition to the extent that transparency is not adversely affected.

The basecoat coating composition and the clearcoat coating composition can be coated wet-on-wet and then simultaneously cured by heating, or the basecoat coating composition can be coated and cured by heating, and then the clearcoat coating composition can be coated and cured by heating.

There is no restriction as a method for coating these topcoat materials, for example, they can be coated by air-spray coating, airless-spray coating, or electrostatic coating, etc.; however, when coated onto the electrically-conductive coating film obtained by coating the electrically-conductive primer coating composition of the present invention, electrostatic coating is preferably used. Although there are no particular restrictions as to thicknesses of the topcoat coating films, dry film thickness is preferably 20-60 μm in the case of the one-coat coating composition, 10-30 μm in the case of the basecoat coating composition, and 15-50 μm in the case of the clearcoat coating composition

These topcoat coating films can be cured at room temperature (25° C.), but in order to obtain adequate coating film properties, they are preferably cured at a temperature of 50-120° C.; 55-110° C. is preferred, and 60-100° C. is preferred. If the curing temperature is 50-120° C., adequate coating film properties can be obtained without causing deformation of the coated material or yellowing of the coating film. Curing time varies with curing temperature, but at a curing temperature of 50-120° C., 5-60 minutes is suitable.

### EXAMPLES

This invention is described more specifically below by means of practical examples; however, this invention is not restricted to these examples. In addition, unless stated otherwise, in the examples “parts” means “parts by mass”; and in relation to contents, “%” means “mass %”.

### Production Example 1

Polytail H (proprietary name, produced by Mitsubishi Chemical Corp.), which is (B) non-chlorinated polyolefin resin which includes a hydroxy group, at 10.0 parts by mass as resin solids, Chezacarb AC50 (proprietary name, produced by Orlen Unipetrol), which is (A) a black electrically-conductive pigment, at 5.0 parts by mass, and titanium oxide pigment TI-PURE R-960 (proprietary name, produced by The Chemours Company), which is a non-electrically-conductive pigment, at 5.0 parts by mass, were weighed out, and diluted with xylene to give a non-volatile content (resin solids+pigment) of 20 mass %. Then, these were dispersed to give a particle size of 20 μm or less by using a LAU-Disperser Model DAS-200 (proprietary name, produced by LAU), to obtain (C) an electrically-conductive paste.

Superchlon 223M (proprietary name, produced by Nippon Paper Industries Co., Ltd.), which is (D) acrylic resin-modified chlorinated polyolefin resin, at 30.0 parts by mass as resin solids, Duranate MF-K60B (proprietary name, produced by Asahi Kasei Corp.), which is (E) a blocked polyisocyanate compound, at 5.0 parts by mass as resin solids, Superchlon 822 (proprietary name, produced by Nippon Paper Industries Co., Ltd.), which is a chlorinated polyolefin resin which does not contain hydroxy groups, at 2.0 parts by mass as resin solids, and jER825 (proprietary name, produced by Mitsubishi Chemical Corp.), which is an epoxy resin, at 3.0 parts by mass, were added to the total quantity of the resulting (C) electrically-conductive paste, and thoroughly mixed to give electrically-conductive primer coating composition P-1.

### Production Examples 2-12 Comparative Production Examples 1-4

Electrically-conductive primer coating compositions P-2 to P-12 and comparative primer coating compositions VP-1 to VP-4 were obtained by the same process as in Production Example 1, with the material formulations presented in Table 1.

### Comparative Example 5

Superchlon 223M (proprietary name, produced by Nippon Paper Industries Co., Ltd.), which is (D) acrylic resin-modified chlorinated polyolefin resin, at 10.0 parts by mass as resin solids, Chezacarb AC50 (proprietary name, produced by Orlen Unipetrol), which is (A) a black electrically-conductive pigment, 5.0 parts by mass, and titanium oxide pigment TI-PURE R-960 (proprietary name, produced by The Chemours Company), which is a non-electrically-conductive pigment, 5.0 parts by mass, without using (B) a non-chlorinated polyolefin resin which includes a hydroxy group, were weighed out, and diluted with xylene to give a non-volatile content (resin solids+pigment) of 20 mass %. Then, these were dispersed to give a particle size of 20 μm or less using a LAU-Disperser Model DAS-200 (proprietary name, produced by LAU), to obtain (C) an electrically-conductive paste.

Superchlon 223M (proprietary name, produced by Nippon Paper Industries Co., Ltd.), which is (D) acrylic resin-modified chlorinated polyolefin resin, at 20.0 parts by mass as resin solids, Polytail H (proprietary name, produced by Mitsubishi Chemical Corp.), which is (B) a non-chlorinated polyolefin resin which includes a hydroxy group, at 10.0 parts by mass as resin solids, Duranate MF-K60B (proprietary name, produced by Asahi Kasei Corp.), which is (E) a blocked polyisocyanate compound at 5.0 parts by mass as resin solids, Superchlon 822 (proprietary name, produced by Nippon Paper Industries Co., Ltd.), which is a chlorinated polyolefin resin which does not contain hydroxy groups, at 2.0 parts by mass as resin solids, and jER825 (proprietary name, produced by Mitsubishi Chemical Corp.), which is an epoxy resin, 3.0 parts by mass, were added to the total quantity of the resulting (C) electrically-conductive paste, and thoroughly stirred, to give comparative primer coating composition VP-5. Comparative primer coating composition VP-5 includes the same material formulation as electrically-conductive primer P-1, but the production process is different.

### <Measurement of Surface Electrical Resistance>

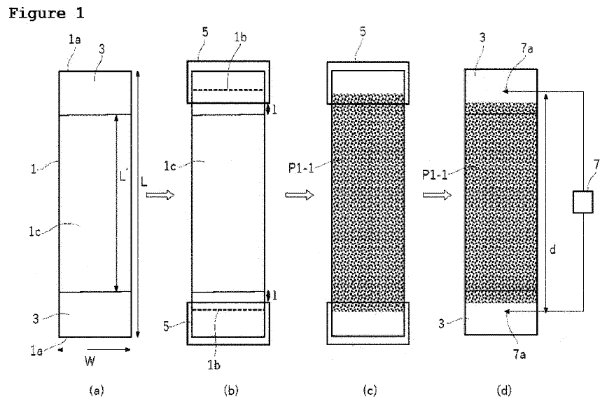

Electrically-conductive primer compositions P-1 to P-12 of the present invention and comparative primer coating compositions VP-1 to VP-5 were coated onto plastic substrate materials, and surface electrical resistance at 30 seconds after coating (30 seconds from the time that coating was completed) was measured. The details of fabrication of the test pieces and the details of surface electrical resistance measurement using FIG. 1(a) to FIG. 1(d) are as follows.

### Example 1-1

FIG. 1(a) is a schematic drawing of a polypropylene plate 1 (length L 15 cm, width W 7 cm, thickness (not shown in the drawing) 3 mm). The surface of the polypropylene plate 1 was wiped with isopropyl alcohol to remove soiling, and commercial aluminium tape 3 (width 3.5 cm) was wound round both ends 1a. With this, the lengthwise centre 1c of the polypropylene plate 1 (length (L′) 8 cm) between the both ends 1a covered by aluminium tape 3 was left exposed.

Moreover, in order to connect an insulation resistance tester 7 (see FIG. 1(d) described below) to the polypropylene plate 1, positions 1b 2.5 cm inside from the both ends 1a of the polypropylene plate 1 were decided as terminal positions 1b to give distance of 10 cm between the terminals 7a of the insulation resistance tester 7, and were pre-marked as shown in FIG. 1(b).

The both ends 1a of the polypropylene plate 1 were then covered by masking tape 5. Here, the masking tape 5 didn't cover the entirety of the aluminium tape 3. Thus, the masking tape 5 was pasted on the aluminium tape 3 so that the aluminium tape 3 at the central portion 1c side of the polypropylene plate 1 left exposed for a distance 1 (5 mm) in the lengthwise direction L of the polypropylene plate 1.

Then, viscosity of the electrically-conductive primer coating composition P-1 was adjusted to 11 seconds with ford cup #4 at 20° C., by dilution with xylene. The electrically-conductive primer coating composition P-1 thus diluted was coated by airless spraying onto the polypropylene plate in the masked state described above, to give a dry film thickness of 7 μm. The polypropylene plate 1 in the coated state is shown in FIG. 1(c).

Soon after the coating, the masking tape 5 was detached, and as shown in FIG. 1(d), the terminals 7a of the insulation resistance tester 7 (3-range insulation resistance meter, Model 3301 (proprietary name, produced by Kyoritsu Electrical Instruments Works, Ltd.)) were fitted to the positions 1b on the aluminium tape 3 at the both ends of the polypropylene plate 1.

The surface electrical resistance at 30 seconds after coating (30 seconds from the time that coating was completed) was measured, and the result is presented in Table 1. It should be noted that the units of the measured values were “×10⁶ Ω”, and the acceptable range was 100×10⁶ Ω or less.

### Examples 1-2 to 1-12 and Comparative Examples 1-1 to 1-5

By the same process as Example 1-1, the surface electrical resistance was measured at 30 seconds after coating the electrically-conductive primer coating compositions P-2 to P-12 of Production Examples 2 to 12 and comparative primer coating compositions VP-1 to VP-5 of Comparative Examples 1 to 5. The results are presented in Table 1.

### <Measurement of the Lightness L* Value of the Primer Coating Films>

A lightness L* value in the CIE LAB colour system (also simply L* value) of the primer coating films obtained from electrically-conductive primer coating compositions P-1 to P-12 of the present invention and comparative primer coating compositions VP-1 to VP-5 was measured as described below.

### Example 2-1

The surface of a polypropylene plate (length 15 cm, width 7 cm, thickness 3 mm) was washed with isopropyl alcohol to remove adhered soiling. The viscosity of the electrically-conductive primer coating composition P-1 of Production Example 1 was adjusted to 11 seconds with ford cup #4 at 20° C. by dilution with xylene.

The electrically-conductive primer coating composition P-1 thus diluted was coated by airless spraying onto the polypropylene plate treated as above, to give a dry film thickness of 7 μm, and cured at 60° C. for 10 minutes. This gave a cured coating film of the electrically-conductive primer coating composition P-1.

The lightness L* value of the resulting electrically-conductive coating film was measured using a spectrophotometer CM-512m3 (proprietary name, produced by Konica Minolta, Inc.). The result is presented in Table 1.

### Examples 2-2 to 2-12 and Comparative Examples 2-1 to 2-5

The lightness L* values of the cured primer coating films of the electrically-conductive primer coating compositions P-2 to P-12 of Production Examples 2 to 12 and comparative primer coating compositions VP-1 to VP-5 of Comparative Examples 1 to 5 were measured by the same process as Example 2-1. The results are presented in Table 1.

### <Water-Resistant Adhesion of Multilayer Coating Films>

A water-resistant adhesion of low-temperature-cured multilayer coating films obtained by using the electrically-conductive primer coating compositions P-1 to P-12 of this invention and comparative primer coating compositions VP-1 to VP-5, was measured as described below.

### 1. Evaluation of Polypropylene (PP)/Primer/Basecoat (BC)/Clearcoat (CC) Multilayer Coating Films

### Example 3-1

The surface of a polypropylene plate (length 15 cm, width 7 cm, thickness 3 mm) as a substrate material was washed with isopropyl alcohol to remove adhered soiling. Then the viscosity of the electrically-conductive primer coating composition P-1 of Production Example 1 was adjusted to 11 seconds with ford cup #4 at 20° C. by dilution with xylene, and it was coated by airless spraying onto the polypropylene plate treated as above, to give a dry film thickness of 7 μm, and left at room temperature for 2 minutes.

Solvent-based basecoat Plymac No. 8800 Silver (proprietary name, produced by BASF Japan, Ltd., one-component acrylic coating composition) was then electrostatically coated to give a dry coating film thickness of 15 μm, and then solvent-based clearcoat Plymac No. 8700 Clear (proprietary name, produced by BASF Japan, Ltd., two-component acrylic/urethane coating composition) was electrostatically coated by wet-on-wet to give a dry coating film thickness of 30 μm, and cured at 60° C. for 10 minutes to give the test piece.

A water-resistant adhesion test was carried out by an adhesion test in accordance with JIS K5400-8.5 (cross-cut test) after the resulting test piece was immersed in warm water at 40° C. for 240 hours. Thus, in the adhesion test in this invention, first, 11 lengthwise cuts and 11 widthwise cuts at 2 mm intervals were made with a cutting knife from the surface of the multilayer coating film to the substrate material, to make a cross-cut grid with 100 squares. Then Sellotape® was pasted over the whole surface of the cross-cut multilayer film, and this was detached. The results of the water-resistant adhesion test here were evaluate by the criteria below; the result is presented in Table 1.
◯: no peeling of the coating film (residual cross-cut pattern 100/100)
Δ: partial peeling of the coating film (residual cross-cut pattern 90-99/100)
X: most of the coating film peeled (residual cross-cut pattern 0-89/100)

### Examples 3-2 to 3-12 and Comparative Examples 3-1 to 3-5

Test pieces were made using the electrically-conductive primer coating compositions P-2 to P-12 of Production Examples 2 to 12 and comparative primer coating compositions VP-1 to VP-5 of Comparative Examples 1 to 5, and the water-resistant adhesion tests were carried out by the same process as Example 3-1. The results are presented in Table 1.

### 2 Evaluation of Polypropylene (PP)/Primer/One-Coat Multilayer Coating Films.

### Example 4-1

The surface of a polypropylene plate (length 15 cm, width 7 cm, thickness 3 mm) as a substrate material was washed with isopropyl alcohol to remove adhered soiling. Then the viscosity of the electrically-conductive primer coating composition P-1 of Production Example 1 was adjusted to 11 seconds with ford cup #4 at 20° C. by dilution with xylene, and it was coated by airless spraying onto the polypropylene plate treated as above, to give a dry film thickness of 7 μm, and left at room temperature for 2 minutes.

Then, a solvent-based one-coat metallic coating Hi-Urethane LM-110 Silver (proprietary name, produced by BASF Japan, Ltd., two-component acrylic/urethane coating composition) was electrostatically coated to give a dry coating film thickness of 35 μm, and cured at 60° C. for 10 minutes to give the test piece. The water-resistant adhesion test was carried out on the resulting test piece by the same process as Example 3-1. The result is presented in Table 1.

### Examples 4-2 to 4-12 and Comparative Examples 4-1 to 4-5

Test pieces were made using the electrically-conductive primer coating compositions P-2 to P-12 of Production Examples 2 to 12 and comparative primer coating compositions VP-1 to VP-5 of Comparative Examples 1 to 5, and the water-resistant adhesion tests were carried out by the same process as Example 4-1. The results are presented in Table 1.

### 3. Evaluation of a Polycarbonate (PC)/Primer/Basecoat (BC)/-Clearcoat (CC) Multilayer Coating Film

### Example 5-1

The surface of a polycarbonate plate (length 15 cm, width 7 cm, thickness 3 mm) as a substrate material was washed with isopropyl alcohol to remove adhered soiling. Then the viscosity of the electrically-conductive primer coating composition P-1 of Production Example 1 was adjusted to 11 seconds with ford cup #4 at 20° C. by dilution with xylene, and it was coated by airless spraying onto the polycarbonate plate treated as above, to give a dry film thickness of 7 μm, and left at room temperature for 2 minutes.

Then, solvent-based basecoat Plymac No. 8800 Silver (proprietary name, produced by BASF Japan, Ltd., one-component acrylic coating composition) was electrostatically coated to give a dry coating film thickness of 15 μm, and then solvent-based clearcoat Plymac No. 8700 Clear (proprietary name, produced by BASF Japan, Ltd., two-component acrylic/urethane coating composition) was electrostatically coated by wet-on-wet to give a dry coating film thickness of 30 μm, and cured at 60° C. for 10 minutes to give the test piece.

The water-resistant adhesion test was carried out on the resulting test piece by the same process as Example 3-1. The result is presented in Table 1.

### Examples 5-2 to 5-12 and Comparative Examples 5-1 to 5-5

Test pieces were made using the electrically-conductive primer coating compositions P-2 to P-12 of Production Examples 2 to 12 and comparative primer coating compositions VP-1 to VP-5 of Comparative Examples 1 to 5 and the water-resistant adhesion tests were carried out by the same process as Example 5-1. The results are presented in Table 1.

TABLE 1

| | | | | Production example | | | | | |
|---|---|---|---|---|---|---|---|---|---|
| | | | | Production | Production | Production | Production | Production | Production |
| | | | | example 1 | example 2 | example 3 | example 4 | example 5 | example 6 |
| Electrically-conductive primer coating | | | | P-1 | P-2 | P-3 | P-4 | P-5 | P-6 |
| composition | | | | | | | | | |
| (C) | (A) | A-1 | Chezacarb | 5.0 | 5.0 | 5.0 | 5.0 | 5.0 | 5.0 |
| electrically- | electrically- | | AC50 | | | | | | |
| conductive | conductive | A-2 | Dentall | | | | | | |
| paste | pigment | | WK-500 | | | | | | |
| | Non- | | TI-PURE | 5.0 | 5.0 | 5.0 | 5.0 | 5.0 | 5.0 |
| | electrically- | | R-960 | | | | | | |
| | conductive | | | | | | | | |
| | pigments | | | | | | | | |
| | (B) non- | B-1 | Polytel H | 10.0 | 5.0 | 20.0 | | | |
| | chlorinated | B-2 | NISSO-PB- | | | | 10.0 | | |
| | polyolefin | | G-3000 | | | | | | |
| | resin which | B-3 | NISSO-PB- | | | | | 10.0 | |
| | includes a | | G-1000 | | | | | | |
| | hydroxyl | B-4 | Unistole | | | | | | 10.0 |
| | group | | p-801 | | | | | | |
| | Non- | | Unistole | | | | | | |
| | chlorinated | | p-902 | | | | | | |
| | polyolefin | | | | | | | | |
| | resin which | | | | | | | | |
| | includes a | | | | | | | | |
| | hydroxyl | | | | | | | | |
| | group | | | | | | | | |
| | acrylic resin- | | Superchlon | | | | | | |
| | modified | | 223M | | | | | | |
| | chlorinated | | | | | | | | |
| | polyolefin | | | | | | | | |

| (D) acrylic resin-modified | D-1 | Superchlon | 30.0 | 35.0 | 20.0 | 30.0 | 30.0 | 30.0 |
|---|---|---|---|---|---|---|---|---|
| chlorinated polyolefin | | 223M | | | | | | |
| resin | D-2 | Superchlon | | | | | | |
| | | 224H | | | | | | |
| | D-3 | Superchlon | | | | | | |
| | | 240H | | | | | | |
| Non-chlorinated | | Polytel H | | | | | | |
| polyolefin resin which | | | | | | | | |
| includes a hydroxyl | | | | | | | | |
| group | | | | | | | | |
| (E) blocked | E-1 | Duranate | 5.0 | 5.0 | 5.0 | 5.0 | 5.0 | 5.0 |
| polyisocyanate | | MF-K60B | | | | | | |
| compound | | | | | | | | |
| Other resins | | Superchlon | 2.0 | 2.0 | 2.0 | 2.0 | 2.0 | 2.0 |
| | | 822 | | | | | | |
| | | jER825 | 3.0 | 3.0 | 3.0 | 3.0 | 3.0 | 3.0 |
| Total | | | 60.0 | 60.0 | 60.0 | 60.0 | 60.0 | 60.0 |
| (A)/((A) + (B)) × 100 | | | 33 | 50 | 20 | 33 | 33 | 33 |
| (B)/((A) + (B)) × 100 | | | 67 | 50 | 80 | 67 | 67 | 67 |
| (B)/((B) + (D)) × 100 | | | 25 | 13 | 50 | 25 | 25 | 25 |
| (D)/((B) + (D)) × 100 | | | 75 | 88 | 50 | 75 | 75 | 75 |
| (B) + (D)/(total resin solids) × 100 | | | 80 | 80 | 80 | 80 | 80 | 80 |
| (A)//(total resin solids) × 100 | | | 10 | 10 | 10 | 10 | 10 | 10 |
| Surface electrical resistance of the | | | Example | Example | Example | Example | Example | Example |
| primer coating film (×10⁶Ω) | | | 1-1 | 1-2 | 1-3 | 1-4 | 1-5 | 1-6 |
| | | | 1 | 20 | 1 | 20 | 1 | 1 |
| Lightness L* value of the primer coating | | | Example | Example | Example | Example | Example | Example |
| film | | | 2-1 | 2-2 | 2-3 | 2-4 | 2-5 | 2-6 |
| | | | 25 | 25 | 25 | 25 | 25 | 25 |
| Water-resistant | 1. PP/BC/CC | | Example | Example | Example | Example | Example | Example |
| adhesion of multilayer | | | 3-1 | 3-2 | 3-3 | 3-4 | 3-5 | 3-6 |
| coating film | | | ∘ | ∘ | ∘ | ∘ | ∘ | ∘ |

| 2. PP/1-coat | Example | Example | Example | Example | Example | Example |
|---|---|---|---|---|---|---|
| | 4-1 | 4-2 | 4-3 | 4-4 | 4-5 | 4-6 |
| | ∘ | ∘ | ∘ | ∘ | ∘ | ∘ |
| 3. PC/BC/CC | Example | Example | Example | Example | Example | Example |

| | | | | | |
|---|---|---|---|---|---|
| 5-1 | 5-2 | 5-3 | 5-4 | 5-5 | 5-6 |
| ∘ | ∘ | ∘ | ∘ | ∘ | ∘ |

| | | | | Production example | | | | | |
|---|---|---|---|---|---|---|---|---|---|
| | | | | Production | Production | Production | Production | Production | Production |
| | | | | example 7 | example 8 | example 9 | example 10 | example 11 | example 12 |
| Electrically-conductive primer coating | | | | P-7 | P-8 | P-9 | P-10 | P-11 | P-12 |
| composition | | | | | | | | | |
| (C) | (A) | A-1 | Chezacarb | 5.0 | 5.0 | 5.0 | 1.0 | 5.0 | 5.0 |
| electrically- | electrically- | | AC50 | | | | | | |
| conductive | conductive | A-2 | Dentall | | | | 25.0 | | |
| paste | pigment | | WK-500 | | | | | | |
| | Non- | | TI-PURE | 5.0 | 5.0 | 25.0 | 9.0 | 5.0 | 5.0 |
| | electrically- | | R-960 | | | | | | |
| | conductive | | | | | | | | |
| | pigments | | | | | | | | |
| | (B) non- | B-1 | Polytel H | 10.0 | 10.0 | 6.0 | 5.0 | 7.0 | 3.5 |
| | chlorinated | B-2 | NISSO-PB- | | | | | | |
| | polyolefin | | G-3000 | | | | | | |
| | resin which | B-3 | NISSO-PB- | | | | | | |
| | includes a | | G-1000 | | | | | | |
| | hydroxyl | B-4 | Unistole | | | | | | |
| | group | | p-801 | | | | | | |
| | Non- | | Unistole | | | | | | |
| | chlorinated | | p-902 | | | | | | |
| | polyolefin | | | | | | | | |
| | resin which | | | | | | | | |
| | includes a | | | | | | | | |
| | hydroxyl | | | | | | | | |
| | group | | | | | | | | |
| | acrylic resin- | | Superchlon | | | | | | |
| | modified | | 223M | | | | | | |
| | chlorinated | | | | | | | | |
| | polyolefin | | | | | | | | |

| (D) acrylic resin-modified | D-1 | Superchlon | | | 18.0 | 15.0 | 21.0 | 10.5 |
|---|---|---|---|---|---|---|---|---|
| chlorinated polyolefin | | 223M | | | | | | |
| resin | D-2 | Superchlon | 30.0 | | | | | |
| | | 224H | | | | | | |
| | D-3 | Superchlon | | 30.0 | | | | |
| | | 240H | | | | | | |
| Non-chlorinated | | Polytel H | | | | | | |
| polyolefin resin which | | | | | | | | |
| includes a hydroxyl | | | | | | | | |
| group | | | | | | | | |
| (E) blocked | E-1 | Duranate | 5.0 | 5.0 | 3.0 | 2.5 | 5.0 | 5.0 |
| polyisocyanate | | MF-K60B | | | | | | |
| compound | | | | | | | | |
| Other resins | | Superchlon | 2.0 | 2.0 | 1.2 | 1.0 | 14.0 | 28.0 |
| | | 822 | | | | | | |
| | | jER825 | 3.0 | 3.0 | 1.8 | 1.5 | 3.0 | 3.0 |
| Total | | | 60.0 | 60.0 | 60.0 | 60.0 | 60.0 | 60.0 |
| (A)/((A) + (B)) × 100 | | | 33 | 33 | 45 | 84 | 42 | 59 |
| (B)/((A) + (B)) × 100 | | | 67 | 67 | 55 | 16 | 58 | 41 |
| (B)/((B) + (D)) × 100 | | | 25 | 25 | 25 | 25 | 25 | 25 |
| (D)/((B) + (D)) × 100 | | | 75 | 75 | 75 | 75 | 75 | 75 |
| (B) + (D)/(total resin solids) × 100 | | | 80 | 80 | 80 | 80 | 56 | 28 |
| (A)//(total resin solids) × 100 | | | 10 | 10 | 17 | 104 | 10 | 10 |
| Surface electrical resistance of the | | | Example | Example | Example | Example | Example | Example |
| primer coating film (×10⁶Ω) | | | 1-7 | 1-8 | 1-9 | 1-10 | 1-11 | 1-12 |
| | | | 1 | 1 | 20 | 50 | 1 | 1 |
| Lightness L* value of the primer coating | | | Example | Example | Example | Example | Example | Example |
| film | | | 2-7 | 2-8 | 2-9 | 2-10 | 2-11 | 2-12 |
| | | | 25 | 25 | 45 | 60 | 25 | 25 |
| Water-resistant | 1. PP/BC/CC | | Example | Example | Example | Example | Example | Example |
| adhesion of multilayer | | | 3-7 | 3-8 | 3-9 | 3-10 | 3-11 | 3-12 |
| coating film | | | ∘ | ∘ | ∘ | ∘ | ∘ | ∘ |

| 2. PP/1-coat | Example | Example | Example | Example | Example | Example |
|---|---|---|---|---|---|---|
| | 4-7 | 4-8 | 4-9 | 4-10 | 4-11 | 4-12 |
| | ∘ | ∘ | ∘ | ∘ | ∘ | ∘ |
| 3. PC/BC/CC | Example | Example | Example | Example | Example | Example |

| | | | | | |
|---|---|---|---|---|---|
| 5-7 | 5-8 | 5-9 | 5-10 | 5-11 | 5-12 |
| ∘ | ∘ | ∘ | ∘ | ∘ | ∘ |

| | | | | Production example | | | | |
|---|---|---|---|---|---|---|---|---|
| | | | | Comparative | Comparative | Comparative | Comparative | Comparative |
| | | | | production | production | production | production | production |
| | | | | example 1 | example 2 | example 3 | example 4 | example 5 |
| Electrically-conductive primer coating | | | | VP-1 | VP-2 | VP-3 | VP-4 | VP-5 |
| composition | | | | | | | | |
| (C) | (A) | A-1 | Chezacarb | 5.0 | 5.0 | 5.0 | 5.0 | 5.0 |
| electrically- | electrically- | | AC50 | | | | | |
| conductive | conductive | A-2 | Dentall | | | | | |
| paste | pigment | | WK-500 | | | | | |
| | Non- | | TI-PURE | 5.0 | 5.0 | 5.0 | 5.0 | 5.0 |
| | electrically- | | R-960 | | | | | |
| | conductive | | | | | | | |
| | pigments | | | | | | | |
| | (B) non- | B-1 | Polytel H | | 8.0 | 2.0 | 32.0 | |
| | chlorinated | B-2 | NISSO-PB- | | | | | |
| | polyolefin | | G-3000 | | | | | |
| | resin which | B-3 | NISSO-PB- | | | | | |
| | includes a | | G-1000 | | | | | |
| | hydroxyl | B-4 | Unistole | | | | | |
| | group | | p-801 | | | | | |
| | Non- | | Unistole | 10.0 | | | | |
| | chlorinated | | p-902 | | | | | |
| | polyolefin | | | | | | | |
| | resin which | | | | | | | |
| | includes a | | | | | | | |
| | hydroxyl | | | | | | | |
| | group | | | | | | | |
| | acrylic resin- | | Superchlon | | | | | 10.0 |
| | modified | | 223M | | | | | |
| | chlorinated | | | | | | | |
| | polyolefin | | | | | | | |

| (D) acrylic resin-modified | D-1 | Superchlon | 30.0 | | 38.0 | 8.0 | 20.0 |
|---|---|---|---|---|---|---|---|
| chlorinated polyolefin | | 223M | | | | | |
| resin | D-2 | Superchlon | | | | | |
| | | 224H | | | | | |
| | D-3 | Superchlon | | | | | |
| | | 240H | | | | | |
| Non-chlorinated | | Polytel H | | | | | 10.0 |
| polyolefin resin which | | | | | | | |
| includes a hydroxyl | | | | | | | |
| group | | | | | | | |
| (E) blocked | E-1 | Duranate | 5.0 | 5.0 | 5.0 | 5.0 | 5.0 |
| polyisocyanate | | MF-K60B | | | | | |
| compound | | | | | | | |
| Other resins | | Superchlon | 2.0 | 34.0 | 2.0 | 2.0 | 2.0 |
| | | 822 | | | | | |
| | | jER825 | 3.0 | 3.0 | 3.0 | 3.0 | 3.0 |
| Total | | | 60.0 | 60.0 | 60.0 | 60.0 | 60.0 |
| (A)/((A) + (B)) × 100 | | | 100 | 38 | 71 | 14 | 33 |
| (B)/((A) + (B)) × 100 | | | 0 | 62 | 29 | 86 | 67 |
| (B)/((B) + (D)) × 100 | | | 0 | 100 | 5 | 80 | 25 |
| (D)/((B) + (D)) × 100 | | | 100 | 0 | 5 | 80 | 75 |
| (B) + (D)/(total resin solids) × 100 | | | 60 | 16 | 80 | 80 | 80 |
| (A)//(total resin solids) × 100 | | | 10 | 10 | 10 | 10 | 10 |
| Surface electrical resistance of the | | | Comparative | Comparative | Comparative | Comparative | Comparative |
| primer coating film (×10⁶Ω) | | | Example 1-1 | Example 1-2 | Example 1-3 | Example 1-4 | Example 1-5 |
| | | | ∞ | 1 | ∞ | 1 | ∞ |
| Lightness L* value of the primer coating | | | Comparative | Comparative | Comparative | Comparative | Comparative |
| film | | | Example 2-1 | Example 2-2 | Example 2-3 | Example 2-4 | Example 2-5 |
| | | | 25 | 25 | 25 | 25 | 25 |
| Water-resistant | 1. PP/BC/CC | | Comparative | Comparative | Comparative | Comparative | Comparative |
| adhesion of multilayer | | | Example 3-1 | Example 3-2 | Example 3-3 | Example 3-4 | Example 3-5 |
| coating film | | | ∘ | x | ∘ | x | ∘ |

| 2. PP/1-coat | Comparative | Comparative | Comparative | Comparative | Comparative |
|---|---|---|---|---|---|
| | Example 4-1 | Example 4-2 | Example 4-3 | Example 4-4 | Example 4-5 |
| | ∘ | x | ∘ | x | ∘ |
| 3. PC/BC/CC | Comparative | Comparative | Comparative | Comparative | Comparative |

| | | | | |
|---|---|---|---|---|
| Example 5-1 | Example 5-2 | Example 5-3 | Example 5-4 | Example 5-5 |
| ∘ | x | ∘ | x | ∘ |

The materials in the table are as follows.
Chezacarb AC50: proprietary name, produced by Orlen Unipetrol, black electrically-conductive pigment
Dentall WK-500: proprietary name, produced by Otsuka Chemical Co., Ltd., white electrically-conductive pigment
TI-PURE R-960: proprietary name, produced by The Chemours Company, titanium oxide pigment
Polytail H: proprietary name, produced by Mitsubishi Chemical Corp., non-chlorinated polyolefin resin which includes a hydroxy group, mass-average molecular weight 13,000, hydroxyl value 46 mgKOH/g
NISSO-PB-G-3000: proprietary name, produced by Nippon Soda Co., Ltd., non-chlorinated polyolefin resin which includes a hydroxy group, mass-average molecular weight 7,800, hydroxyl value 27 mgKOH/g
NISSO-PB-G-1000: proprietary name, produced by Nippon Soda Co., Ltd., non-chlorinated polyolefin resin which includes a hydroxy group, mass-average molecular weight 4,900, hydroxyl value 73 mgKOH/g
Unistole P-801: proprietary name, produced by Mitsui Chemicals Inc., non-chlorinated polyolefin resin which includes a hydroxy group mass-average molecular weight 86,000, hydroxyl value 40 mgKOH/g
Unistole P-902: proprietary name, produced by Mitsui Chemicals Inc., non-chlorinated polyolefin resin which does not contain hydroxy groups, mass-average molecular weight 80,000
Superchlon 223M: proprietary name, produced by Nippon Paper Industries Co., Ltd., acrylic resin-modified chlorinated polyolefin, mass-average molecular weight 57,000, hydroxyl value 20 mgKOH/g, chlorine content 5.0 mass %
Superchlon 224H: proprietary name, produced by Nippon Paper Industries Co., Ltd., acrylic resin-modified chlorinated polyolefin, mass-average molecular weight 70,000, hydroxyl value 56 mgKOH/g, chlorine content 13.0 mass %
Superchlon 240H: proprietary name, produced by Nippon Paper Industries Co., Ltd., acrylic resin-modified chlorinated polyolefin, mass-average molecular weight 84,000, hydroxyl value 7 mgKOH/g, chlorine content 4.5 mass %
Duranate MF-K60B: proprietary name, produced by Asahi Kasei Corp., malonic acid diester-blocked polyisocyanate compound
Superchlon 822: proprietary name, produced by Nippon Paper Industries Co., Ltd., chlorinated polyolefin resin which does not contain hydroxy groups, mass-average molecular weight 65,000, chlorine content 24.5 mass %
jER825: proprietary name, produced by Mitsubishi Chemical Corp., epoxy resin, epoxy equivalent 175, liquid at room temperature (25° C.)

Above, the invention devised by the present inventors has been described in specific terms based on practical embodiments; however, needless to say, this invention is not restricted to the practical embodiments above, and diverse variations are possible within the essence thereof.

### KEY

1 . . . polypropylene plate (substrate material)
3 . . . aluminium tape
5 . . . masking tape
7 . . . insulation resistance tester
P-1 . . . electrically-conductive primer coating composition

1. An electrically-conductive primer coating composition comprising:
(C) an electrically-conductive pigment paste produced by dispersing (A) an electrically-conductive pigment in (B) a non-chlorinated polyolefin resin comprising hydroxy groups,
(D) an acrylic resin-modified chlorinated polyolefin resin, and
(E) a blocked polyisocyanate compound.

2. The electrically-conductive primer coating composition according to claim 1 wherein the mass ratio of resin solids of the aforementioned (B) non-chlorinated polyolefin resin comprising hydroxy groups to the (D) acrylic resin-modified chlorinated polyolefin resin is 10/90-60/40.

3. The electrically-conductive primer coating composition according to claim 1 wherein the sum of resin solids of the aforementioned (B) non-chlorinated polyolefin resin comprising hydroxy groups and the (D) acrylic resin-modified chlorinated polyolefin resin, is 10 parts by mass or more in 100 parts by mass of total resin solids in the electrically-conductive primer coating composition.

4. The electrically-conductive primer coating composition according to claim 1 wherein the hydroxyl value of the aforementioned (B) a non-chlorinated polyolefin resin comprising a hydroxy group, is 15-90 mgKOH/g.

5. The electrically-conductive primer coating composition according to claim 1 wherein the mass-average molecular weight of the aforementioned (D) acrylic resin-modified chlorinated polyolefin resin is 20,000-150,000.

6. The electrically-conductive primer coating composition according to claim 1 wherein the aforementioned (E) blocked polyisocyanate compound is an active-methylene-blocked polyisocyanate compound.

7. The electrically-conductive primer coating composition according to claim 1 wherein the aforementioned (A) electrically-conductive pigment comprises a black electrically-conductive pigment and/or a white electrically-conductive pigment.

8. A process for producing an electrically-conductive primer coating composition, comprising:
making (C) an electrically-conductive pigment paste by dispersing (A) an electrically-conductive pigment in (B) a non-chlorinated polyolefin resin comprising hydroxy groups, and then
mixing the aforementioned (C) electrically-conductive pigment paste, (D) an acrylic resin-modified chlorinated polyolefin resin, and (E) a blocked polyisocyanate compound.

9. A primer coating film which is a dried coating film of the electrically-conductive primer coating composition described in claim 1.

10. The primer coating film according to claim 9 wherein a lightness L* value in the CIE LAB colour system is 20-70 on plastic substrate material.

11. The primer coating film according to claim 9 wherein a film thickness of the dry coating film is 2-20 μm.

12. A process for forming a multilayer coating film, comprising:
a step (1) of coating the electrically-conductive primer coating composition according to claim 1 onto plastic substrate material, and forming an electrically-conductive primer coating film, coating a one-coat coating composition onto the electrically-conductive primer coating film obtained in the step (1) above, and curing.

13. A process for forming a multilayer coating film, comprising:
a step (1) of coating the electrically-conductive primer coating composition according to claim 1 onto plastic substrate material, and forming an electrically-conductive primer coating film,
a step (2) of coating a basecoat coating composition onto the electrically-conductive primer coating film obtained in the step (1) above
to obtain a basecoat coating film,
coating a clearcoat coating composition onto the basecoat coating film obtained in the step (2), and curing.
